(19) United States
(12) Patent Application Publication
(10) Pub. No.: US 2015/0020420 A1
(43) Pub. Date: Jan. 22, 2015

(54) Pair Handheld Collapsible Action Sign

(71) Applicant: Odie Lee Dancer, Oakland, CA (US)

(72) Inventor: Odie Lee Dancer, Oakland, CA (US)

(21) Appl. No.: 14/314,173

(22) Filed: Jun. 25, 2014

Related U.S. Application Data
(60) Provisional application No. 61/842,192, filed on Jul. 2, 2013.

(51) Int. Cl. G09F 21/02

(52) U.S. Cl. CPC G09F 21/02; G09F 2007/1878
USPC 40/586

(57) ABSTRACT

The presenting embodiments methodizing producing assorted collapsible rotating predetermined designed and measured signs offering but not limiting to handheld possibilities encompassing assorted advertising print or methods capturing attentiveness of others in exchange for response or feedback. Various predetermined designed and measured material matter usually determines its finish and function produced to fit comfortable for its users and their needs. Currently a predetermined designed and measured housing unit including 3 voids, predetermined designed and measured shapes with various print methods and predetermined designed and measured pair handles are included to achieve an evaluated collapsible measure.

### CROSS-REFERENCED TO RELATED APPLICATIONS

This application Claims the benefit of Provisional Patent Application 61/842,192

### BACKGROUND

### Prior Art

The following is a synopsis of some similar art that appears applicable:

| | Kind | U.S. Patent | |
|---|---|---|---|
| Patent Number | Code | Issue Date | Patentee |
| 1.) 6,793,460 | B2 | 2004 Sep. 21 | Langdon DuBois |
| 2.) 7,347,670 | B1 | 2008 Mar. 25 | Cynthia Chisholm Henderson |
| 3.) 201220011753 | A1 | 2012 Jan. 19 | Miroslan Ivanovic |
| 4.) 8,091,260 | B2 | 2012 Jan. 10 | Kenneth Armwood |
| 5.) 5,276,424 | A1 | 1994 Jan. 04 | John J. Hegemann |
| 6.) 5,694,711 | A1 | 1992 Dec. 09 | John H. Cowgill, Otis |
| | | | Charles W. Elroy, Jr. |

Capturing attentiveness or response of an eyewitness usually requires an excellent well provoked “action” For this example of accommodating drawings and print a pedestrian can achieve the above by displaying a collapsing sign labeled “STOP” with comfort as needed to cross an intersection to capture driver's attention.

As for this invention claims various collapsible sign shapes, colors, language and other related matter, with a conceptualized function as that of a fan will embody as to the spirit and scope any adaptions or modifications including diverse handle options for “action” as a means for utility and industrialization within any particular field which requires capturing said responses or feedback within said sign advertisement.

Signs and fans alike have been known as used for centuries to convey us all. This can be discovered within the below recommended background art:

U.S. Pat. Nos. 6,793,460, 7,347,670, 201220011753, U.S. Pat. Nos. 8,091,260, 5,276,424 and 5,694,711. A few of the above popularize lighting and electricity, while others popularize size. Heaviness of objects and issues associated with light or electricity can sometimes cause deterrence's or pose risks.

Typically most signs and fans can resemble in framework and but lack combined elements related to that of both. Since the beginning of time, most fans have been marketed and sold as a circular functioning end product, but lacking durability and strength only to that as paper. On the other hand when not said circular functioning they often lack alternative embodiments. Signs depending on size, usually either lack embodiments or embody a countless number of detachable pieces just to accomplish a displayed message and collapsible goal.

### SUMMARY OF INVENTION

The present invention calls for a predetermined designed and measured pair handled arc collapsible action sign displaying selected or mixed predetermined designed and measured printed matter, color (includes fluorescents) within a predetermined designed and measured material matter shape with means of light emitting or illuminating object matter (or non-light emitting) in a predetermined position, such as boarders for an overall desired response, as that of an exposed handheld sign labeled “STOP” Sign boarder options are predetermined, notably for signs made of fabric matter but not to exclude other material mater. Said predetermined designed and measured material matter shapes can be made of nylon and other weatherized or fabric matter that usually require a predetermined number of designed and measured rib matter for durability. A then predetermined designed and measured housing unit secures said rib matter in a pre-measured slightly overlapping bellow like circular unison motion and said predetermined pair handles together with predetermined measured and designed pin or peg matter. Then said rib matter sandwiching two or more fabric shapes for mending each said rib matter and boarder to said sign fabric shape to prepare the device for example to an arc trajectory. Metal, plastic and other properties of material matter are pre-fabricated cut shapes in pieces, concluded with predetermined designed and measured printed matter all in a disseminated slight overlapping bellow like circular unison. Along shaped edges are premeasured voids, which for this example could require a filtering material matter or circular shaped filtering material matter to set the sign in motion to perform for example to an arc trajectory after first being secured to said housing unit and said pair handles by said pin or peg matter. Said pair handles forcefully pulled in their proper direction guarantees success of said arc trajectory. Mounted to said pair handles is a predetermined designed and measured protectant which acts as a locking/unlocking device securing said handles and all contents after the user performs each arc trajectory with the device.

Additional embodiment: Accommodating said sign is a predetermined designed and measured predetermined sign mask with choice of colors and printed matter, imitating the fully erect shaped sign. Said mask can be light emitting or non-light emitting. Embodiments for securing the mask over the device will include countless numbers of interlocking options secured by countless material matter options. One such example is a predetermined designed and measured padlock with a key member that attaches to said sign mask.

Any additional embodiments including above as a means for utility, industrializing and modifying this invention are within stationary structures.

Furthermore, up to this point, while present embodiments of the invention has been documented in some detail to enable a person of skilled in the relevant art to make and use the same, it should be obvious that various other adaptions and modifications can be envisioned by those persons skilled in such art without departing from either the spirit or scope of the inventions claims that will be provided.

Accordingly, several advantages of one or more aspects are as follows: To provide a said handheld “action” sign advertising displayed said printed matter as a process to capture said responses or feedback as it relates to any given field or endeavor. It's versatility to accommodate virtually any predetermined shape, size, color, language and inscription. Furthermore, it accommodates the user with the upmost comfort ability to freely multitask. Specially made to be personalized and relates to education and those with disabilities.

At present, one or more of these advantages will be apparent from the below drawings.

### DRAWINGS

### Figures

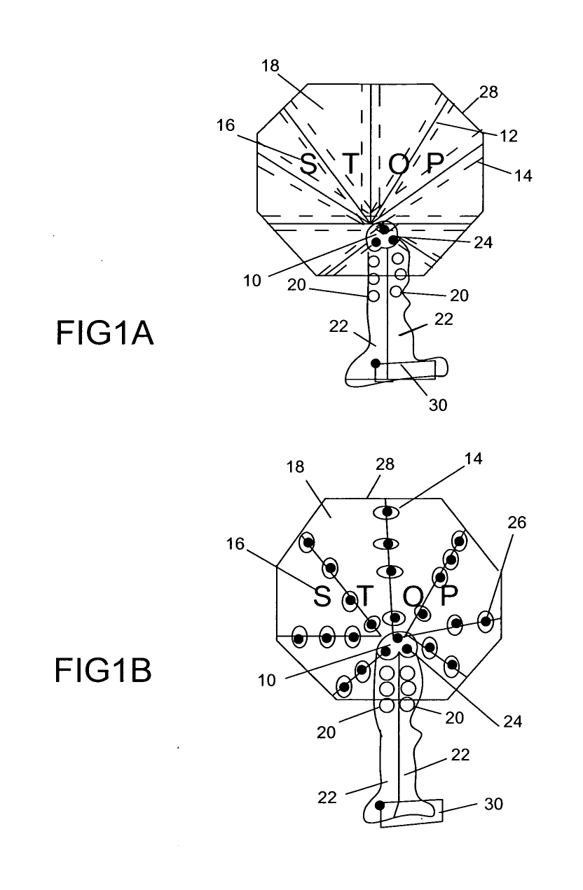

FIGS. 1A and 1B—Face of design. 1A fabric matter depiction. 1B plastics, metals woods or other related material matter depiction. Backsides are duplicate or made up of other predetermined matter. Lower sign matter secured to said handles for example by predetermined designed and measured pin or peg matter as a means for completing sign shape, stability, durability, proper masking of elements and current preferred embodiment of arc trajectory projected for unison with all other said elements.

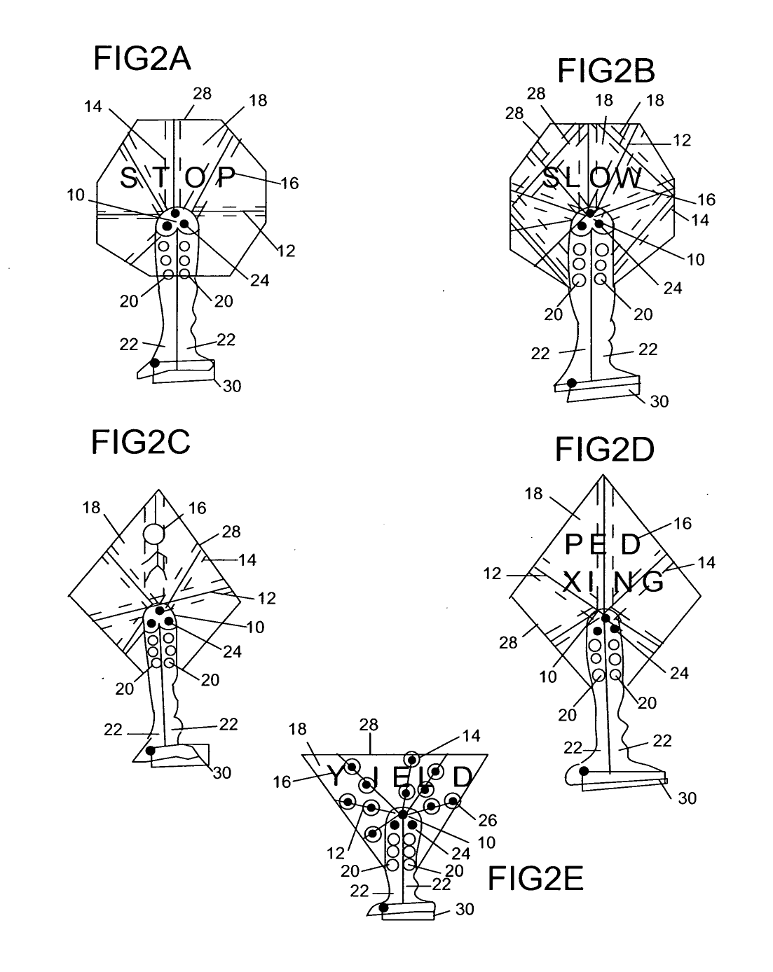

FIG. 2A-2E—Depicts an example of predetermined designed and measured various sign shapes, predetermined designed and measured printed matter and colors.

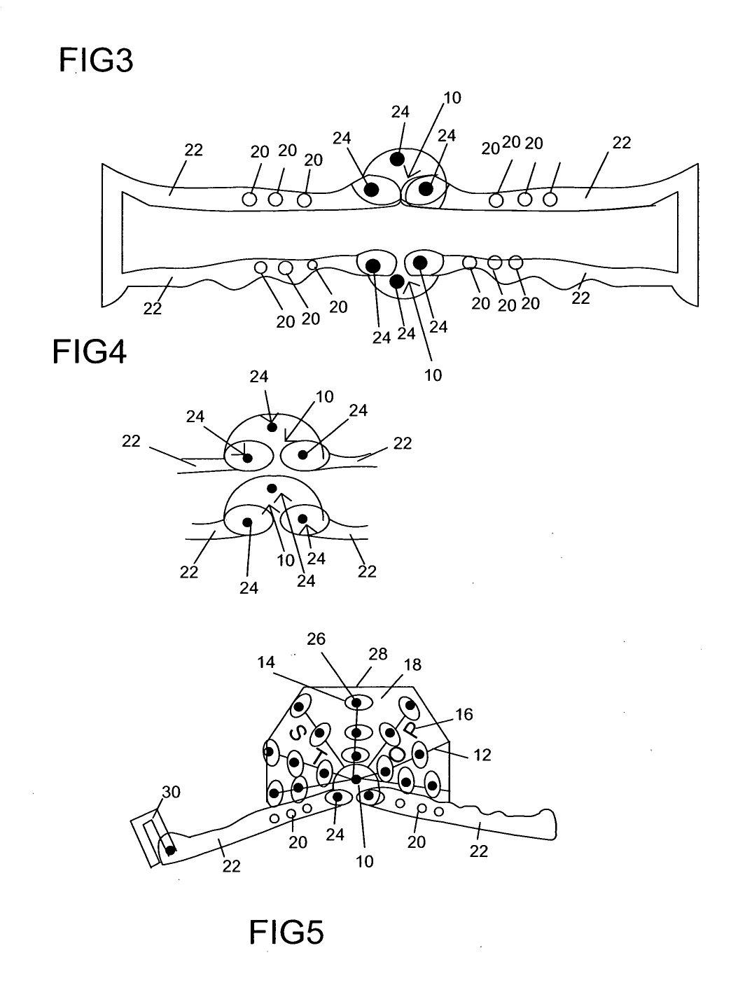

FIG. 3—Inside view of predetermined designed and measured pair handles secured to predetermined designed and measured housing unit by pin or peg matter. For this example a connected predetermined 3 void housing where top void (depicted by double end arrows) connects to predetermined designed and measured rib matter (for FIGS. 1A and 1B) then secured by predetermined designed and measured pin or peg material matter.

FIG. 4—Said pin or peg matter sealing said handles and said rib matter also (FIG. 1A).

FIG. 5—Depicting example of arc trajectory collapsing.

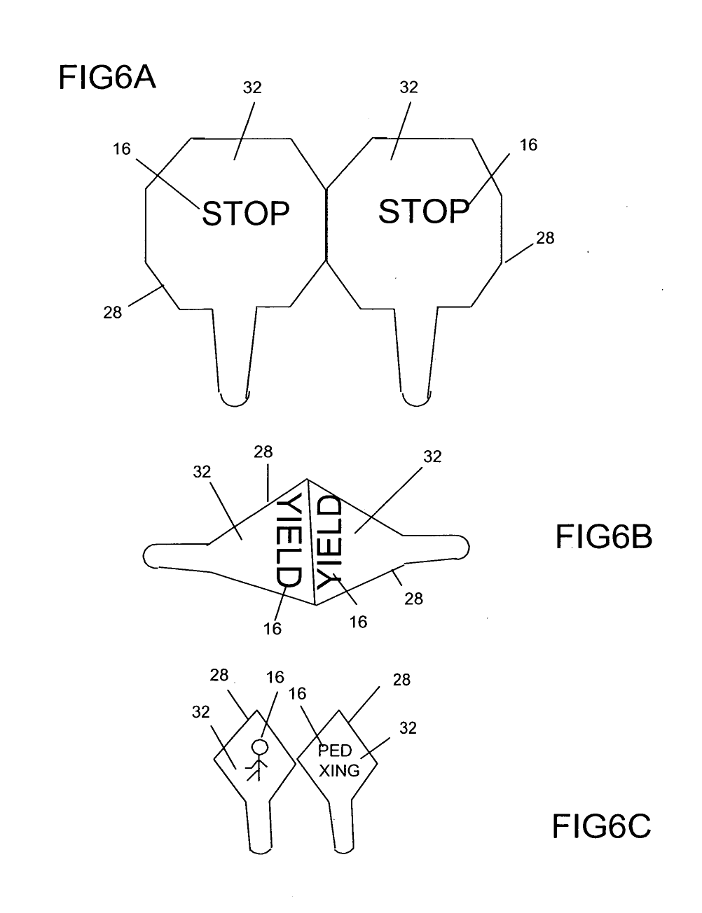

FIG. 6A-6C—This additional embodiment explores and currently depicts a predetermined designed and measured mask for the sign that is a double sided view of inside with predetermined designed and measured printed matter exposed.

### REFERENCED NUMERALS

10.) Predetermined measured and designed housing unit.

12.) Predetermined measured and designed rib matter.

14.) Mended sign fabric matter/Void filtering matter.

16.) Predetermined designed and measured printed matter.

18.) Predetermined designed and measured sign shape (Fabric. Plastic, metal, wood other related material matter are usually separated in predetermined designed and measured pieces).

20.) Predetermined designed and measured pin or peg matter secure lower sign shape to inside of predetermined said pair handles.

22.) Predetermined designed and measured pair handles

24.) Predetermined designed and measured pin or peg matter to secure housing voids.

26.) Voids along edges pre-fab shaped pieces.

28.) Predetermined designed and measured sign boarder.

30.) Predetermined designed and measured sign protectant.

32.) Predetermined designed and measured sign mask.

One embodiment as illustrated in FIG. 1A and 1B. FIG 1A consists of a currently known predetermined housing unit containing 3 voids (10) (FIG. 3) said voids (lower two) secure predetermined designed and measured pair handles (22) by predetermined designed and measured pin or peg matter (24). Predetermined designed and measured rib matter (12) then secured between said housing unit (10) within a slight overlapping bellow like circular unison sandwiching said housing unit (10) and said pair handles (22) top void is then secured by said pin or peg matter (24). A predetermined designed and measured sign shape (fabric-two) (18) containing predetermined designed and measured printed matter (16) with said rib matter (12) sandwiching said signed shape (two) (18) and said printed matter (16). Said rib matter (12) is secured to said sign shape by way of mending (14). If applicable, predetermined designed and measured sign boarders (28) (covers whole entire said sign shape) (18). The lower portion of said sign shape (18) and said sign boarders (28) are secured by predetermined designed and measured pin or peg matter (lower) (20) to inside said pair handles (22) producing sign to collapse within arc trajectory.

FIG. 1B illustrates the overall modified collapsible arc trajectory function as 1A as said sign shape (18) (plastic, metal, wood or related matter in shape pieces) acts as both said sign shape (18) and said rib matter (12) in that the said sign shape (18) is presented in pieces that are prefabricated with said printed matter (16) and contain voids along edges (26). Said housing unit (10) voids (lower two) secures said pair handles (22) by said pin or peg matter (24). Said shape pieces (18) and said voids (26) are then fit to slightly overlap each other in a bellow like circular unison between said housing unit (10) where said pieces (18) sandwiching said housing unit (10) and said pair handles (22). Top void is then secured with said pin or peg matter (24). Then said voids (26) are then properly sealed with a void filtering matter (14) and said shape pieces (two lower pieces) (18) are secured inside (lower) of said pair handles (22) by pin or peg matter (20).

FIG. 2A-2E Exemplifies said sign shapes (various), printed matter and colors achievable with current embodiments. FIG. 2B depicts shape within a shape which is commonly seen on a traffic hand held sign displaying both orange and black colors.

FIG. 3 Illustrates an inside view of said pair handles (22) while said pair handles (22) are secured to said housing unit (10) by said pin or peg matter (24). For this example said rib matter (12) connects to exemplified 3 void housing unit (10) top void (for FIG. 1A) or (18) (for FIG. 1B) said rib matter (12) or said shape (plastic, metal, wood or other related matter) (18) are positioned within a slight overlapping bellow like circular unison, then said top void is secured by said pin or peg matter (24).

FIG. 4 specifically points to said voids (24) securing said pair handles (22) said rib matter (12) and or sign shape (18). With properly connected said pin or peg matter (24). Said pair handles (22) can be pulled in the proper direction to execute an arc trajectory with all other elements following within place.

Operation—FIG. 5 shows an example of a current embodiment in operation as the said pair handles (22) are tugged apart. As tugging continues, it becomes apparent lower sign connected by pin and peg matter that secures lower sign shape (20) and said measured sign boarders (28) said sign shape (18) said measured printed matter (16) said rib matter (12) said mended sign fabric matter/Void filtering matter (14) said voids along edges pre-fab shaped pieces (26) said housing unit (10) said pin or peg matter to secure housing voids (24) all dissolves inside the said pair handles (22). Once said pair handles edges touch at any end of said arc trajectory, the predetermined designed and measured sign protectant (30) secures said pair handles (22).

FIG. 6A-6C Illustrates a drawing of a double sided open or inside view of a predetermined designed and measured sign mask (32) with various said printed matter (16), color and sign shapes (18). Other options which may not be depicted but described through the above embodiments for securing said sign mask (32) over the device are said to include countless numbers of interlocking options secured by countless material matter options.

What is claimed is:

1. A sign comprising:
A predetermined designed and measured shape made of predetermined designed and measured material matter.
A predetermined designed and measured housing unit for linking various elements.
A predetermined designed and measured pair handles. Where said predetermined designed and measured shaped sign made of predetermined designed and measured material matter attached to said predetermined designed and measured housing unit and predetermined designed and measured paired handles.
